(19) United States
(12) Patent Application Publication
(10) Pub. No.: US 2011/0133467 A1
(43) Pub. Date: Jun. 9, 2011

(54) Kinetic energy recycling system for usable electric and hydraulic power generation

(76) Inventor: Robert A. Stiles, Grand Island, NE (US)

(21) Appl. No.: 12/592,958

(22) Filed: Dec. 7, 2009

(51) Int. Cl. F03D 9/00; F03B 13/00

(52) U.S. Cl. 290/55; 290/54

(57) ABSTRACT

A process that allows the recycling of kinetic energy that is present through the motion of fluid and air transfer. This process shall utilize the use of an impeller assembly that will be introduced into the fluid or air stream of an agricultural or manufacturing process examples are but not limited to irrigation, fan exhaust and air circulation. The fluid or air passes over the impeller recycling the kinetic energy from the motion of this medium to into rotational energy. This rotational energy is conveyed to a generating unit that coverts the recycled energy into usable energy. This usable energy can then be sent back to the process that created it or transferred onto the public utility power grid. This process will be a means of recycling the energy that we use everyday to be used again with no hazard to the environment.

### BACKGROUND OF INVENTION

1. Field of the Invention

The present invention relates to the development of a means for capturing and the recycling of kinetic energy from already existing energy sources into usable energy as an alternate energy power supply for equipment or return to the public power grid.

2. Background of the Invention Prior Art

There are limitations with previous hydroelectric applications. The problem with dammed up streams and waterfalls is the cost and hindrance of location relative to the power generation facility. Srybnik, U.S. Pat. No. 7,605,490 date of issue Oct. 20, 2009 was developed to try and use the energy from lower pressure streams as described in. This unit uses a secondary pump to increase the pressure to the impeller which adds to the energy demand of the system. Sipp, U.S. Pat. No. 7, 602,076 date of issue Oct. 13, 2009 will have the concern of low or lost water flow during drought conditions with units that utilize streams and small rivers. Davis, legal representative, et al. U.S. Pat. No. 7,471,009 Dec. 30, 2008 describes a sea submersible apparatus that is high cost and limited to the coastal areas.

Kj.ae butted.r, U.S. Pat. No. 7,607,304 date of issue Oct. 27, 2009 uses a turbine assembly driven by high pressure steam. There are concerns with the danger of using high pressure steam. There is also the damage that high pressure steam and thermal shock can have on turbines and internal components. The control of pollution is also a concern when fossil fuels such as coal and gas are burned; harmful substances are released into the atmosphere that damages the air we breathe and the ecosystem that people live in. In the northeast United States, acid rain produced by these chemicals released into the air kills plants and crops. There is also the cost of transporting this fuel to the power generating site.

Cripps, U.S. Pat. No. 7,452,160 date of issue Nov. 18, 2008 describes a system that suggests using waste water flow to power turbines to generate electrical power. This system is restricted to highly populate municipal locations to have a waste water system with enough water flow to capture the energy to drive the system.

Heidel, U.S. Pat. No. 7,190,088 date of issue Mar. 13, 2007 also utilizes municipal water flow which is limited to highly populate municipal locations to supply water flow to support the energy generating system. There is no mention of using the generated energy to then supply energy back to the existing water flow system.

### BACKGROUND OF INVENTION OBJECTS AND ADVANTAGES

My Kinetic Energy Recycling System has many advantages and they are:

(a) To recycle the already existing kinetic energy that is created and captured in any man-made fluid and air conveying system.

(b) There is no need for additional booster pumps to increase the amount of energy or pressure delivered to the turbine, water wheel or rational energy conveying device.

(c) The fluid that is present in irrigation systems is already pressurized thus delivering a consistent fluid flow to pass over the turbine, water wheel or rational energy conveying device.

(d) There is enough kinetic energy to supplement and/or support the energy needs of the irrigation and fluid flowing systems.

(e) There is no additional energy use to capture the kinetic energy from air conveying system exhausts. This is free energy that is exhausted to the atmosphere.

(f) There is no hazardous impact to the environment because the kinetic energy is already present in the existing fluid and air conveying systems but has not been captured and recycled to a usable form of energy.

(g) The energy that creates the kinetic energy that is being captured and recycled into usable energy is going to be used to power the existing system whether the kinetic energy is recycled or not so there is no added demand on the utility system.

(h) The recycling of this kinetic energy will lessen the energy demands on the public power grid during the summer months when both the public for cooling and the agricultural community for irrigation are in need of electrical energy.

(i) The exhausted air flow from air conveying systems will provide a consistent and controllable energy source that will provide a far greater efficiency over natural wind turbines.

### SUMMARY

This process will allow us to create usable energy by recycling the kinetic energy that is created by agriculture and industry utilizing man-made motion systems every day. The creation of this usable energy will have no hazardous impact on the environment. It will give us the ability to lessen the energy demand on our public energy supply grid.

These agricultural irrigation systems are used every day to provide us with food and goods that are used in our lives. This process recycles that energy in a way that can be reused by the very system that created it. This process also reaches the rural areas of the country where the energy is being used for irrigation.

This process will capture the kinetic energy that is exhausted in to the atmosphere on a daily basis by industry. Industry exhausts a consistent energy source by means of air flow from fans used on dryer, cooler and air circulating systems. Through this process existing industry can give back to the communities that they provide for.

There will continue to be an increasing demand for food in the world and thus more and more remote areas will be utilized for crop production. This process will lessen the demand of energy to irrigate these areas. The reduction in overall energy demand will allow for smaller energy generating systems needed to operate larger irrigation systems. Though irrigation is a key industry that would be able to utilize this process, the process is not limited to just this application. Any means by which fluid, air or a combination of these is set in motion shall have the potential to utilize this process.

### BRIEF DESCRIPTION OF DRAWINGS

FIG. 1 is an overall view of the design and approach of the Kinetic Energy Recycling System for usable energy generation from a device utilized to convey a fluid which in turn can be reused by the same system that generated the fluid in motion for all or portion of the systems energy demand.

FIG. 2 is an overall view of the design and approach of the Kinetic Energy Recycling System for usable energy generation electric, hydraulic or a combination from a system utilized to convey a fluid which in turn can be reused by the same system that generated the fluid in motion for all or portion of the systems energy demand.

FIG. 3 is a cutaway view of the impeller assembly in its operating position inside a pipe, vessel or exhaust depicting flow of air, fluid or a combination across the impeller assembly.

FIG. 4 is a detailed top view of the impeller assembly and the components that make up the impeller assembly.

FIG. 5 is a depiction of the pipe, vessel or exhaust flange and housing for the kinetic energy recycling unit.

FIG. 6 is an overall view of the design and approach of the Kinetic Energy Recycling System for usable energy generation from a system utilized to convey airflow which in turn can be reused by the same system that generated the airflow in motion for a portion of the systems energy demand or returned to the public utility power grid.

### DRAWINGS REFERENCE NUMERALS

5 pump
10 piping from a pump or air conveying device
15 complete impeller assembly
15A impeller assembly fins
15B impeller assembly hub
15C key stock for shaft and hub
15D impeller assembly set screw
20 flanged housing for encompassing the impeller
25 shaft for mounting impeller assembly
30 bearings for holding shaft and assembly in position
35 flange attached to the pipe or vessel containing the flowing fluid
40 rotational energy transfer device
45 generator for producing electrical energy
50 hydraulic power generation unit
55 automatic transfer switch for relaying usable energy to irrigation system components or back to the public power grid
60 electrical drive motors for irrigation towers
60A hydraulic drive motors for irrigation towers
65 electric power supply lines from Automatic Transfer Switch
70 hydraulic fluid supply hoses from hydraulic power supply unit
75 air conveying device

### DETAILED DESCRIPTION

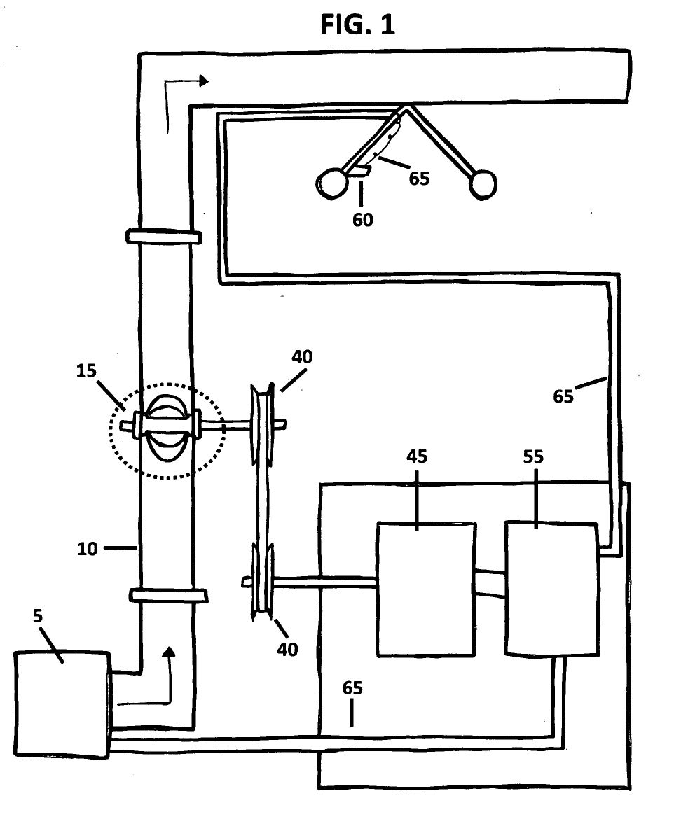

The preferred embodiment shall be described in the terms of the FIGS. 1-5. Identical elements contained in various figures are designated with the same numeral in each figure.

FIG. 1 shows the overall approach and design of the Kinetic Energy Recycling System. The system shown is comprised of an impeller assembly 15 connected to a shaft 25 which then by means of rotational energy transfer device 40 or other coupling arrangement transfers the rotational energy from the impeller assembly 15 to the generator for producing electrical power 45. The generated electrical energy from 45 is than conveyed by wires to the automatic transfer switch 55 which distributes this usable energy to the electric drive motors of the irrigation towers 60 and the electrical motor that powers the well 5. In the event the well is powered by fossil fuel, 55 would send electrical power to recharge the well motor batteries, not shown in FIG.

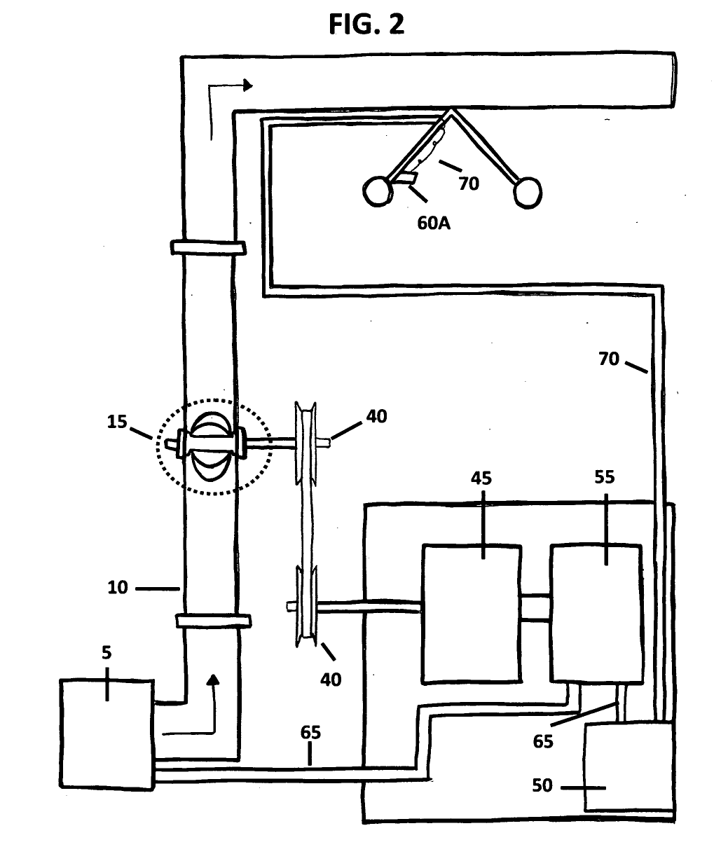

FIG. 2 shows the same overall approach and design of the system as FIG. 1 except for the variation that the drive motors for the towers are hydraulic 60a instead of electric. The powering of these hydraulic motors has various options. One option could be to utilize the rational energy from the impeller assembly 15 by means of a conveying device 40 to drive a hydraulic power generation unit 50 which in turn powers each of the hydraulic drive motors 60A for the towers. A second option would be to power a hydraulic power generation unit 50 with an electric motor that has its electrical power supplied from the automatic transfer switch 55 through the use of electric power supply lines from Automatic Transfer Switch 65. Either option will then transfer the hydraulic energy by means of hydraulic fluid supply hoses 70 to the hydraulic drive motors for irrigation towers 60A.

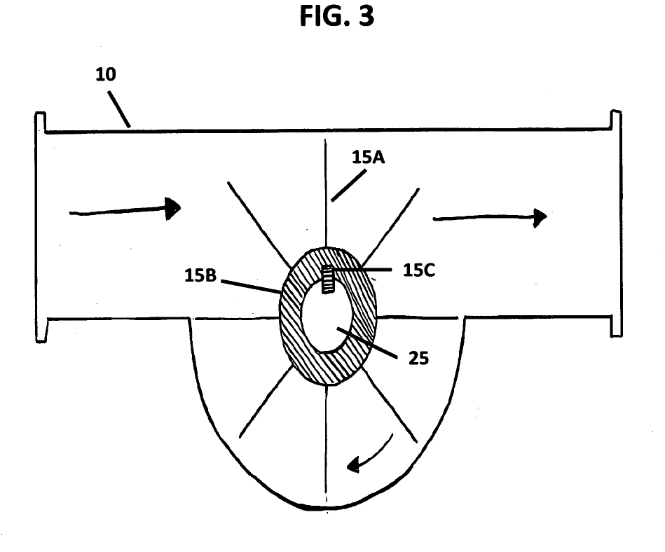

FIG. 3 shows a cutaway view of the impeller assembly 15 in the operating position inside of the pipe or vessel 10. In this illustration one can see the actual mechanics that take place as the fluid passes over the impeller assembly 15. The impeller assembly 15 transfers the rotational energy onto the shaft 20 that the impeller assembly 15 is fastened to by use of key stock 15C and set screw 15D.

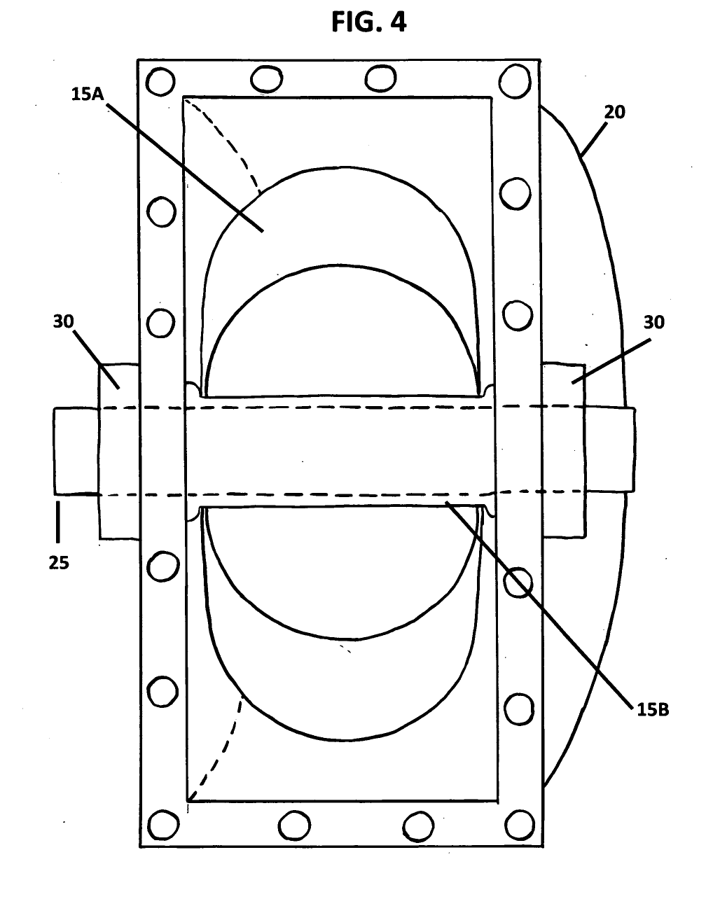

FIG. 4 shows the separate components of the impeller assembly 15. The fins 15A are attached to a hub 15B which is held in place by a piece of key stock 15C and a set screw 15D. There are no specific dimensions because sizing could vary per application in relation to the size of the piping, vessel or transfer component.

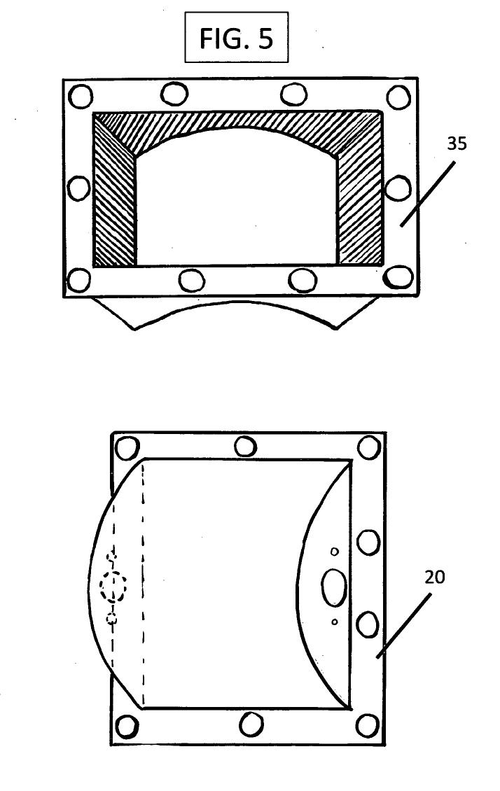

FIG. 5 shows the flange on the adaptor for the pipe or exhaust stack 35 and the flange on the housing used to cover and seal the impeller assembly 20.

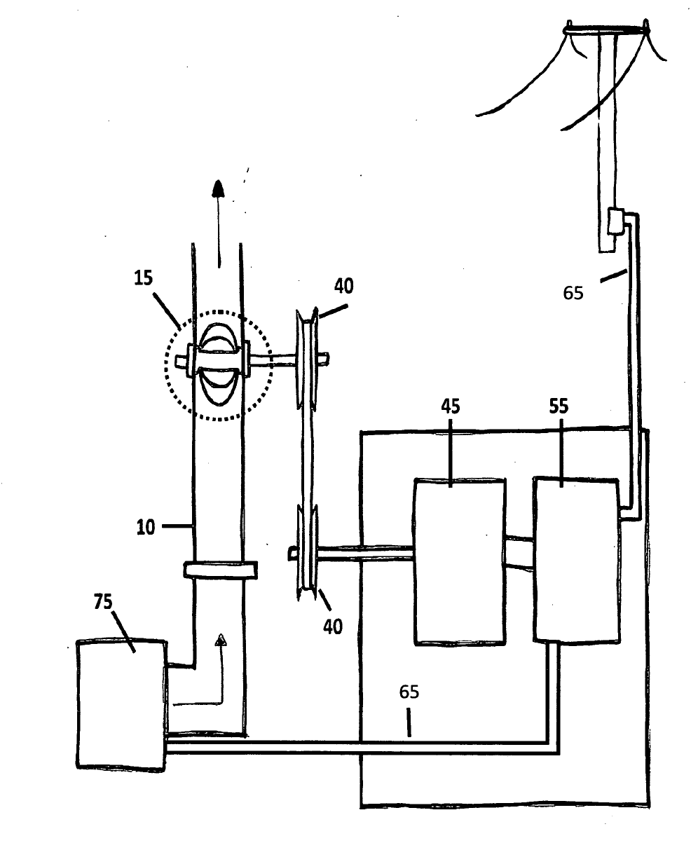

FIG. 6 is a depiction of the impeller assembly 15 mounted on the exhaust point of an air conveying system to capture the kinetic energy and recycle this energy from the exhausted air flow. The kinetic energy is transformed into rotational energy whereby the rotational energy is then transferred to the generator 45. At this time the converted usable energy is conveyed to automatic transfer switch 55 by means of electric power supply lines 65 and from the automatic transfer switch conveyed by means electric power supply lines 65 sent back to the public power grid or returned back to the industry that used the air conveying equipment.

### DETAILED OPERATION

The operation of the process starts with the fabrication of the impeller assembly 15 and then the housing 20. These components of the system shall be made out of strong and durable material that will withstand the pressure of the fluid contained in a pipe 10, vessel or transferring component. The dimensions of the impeller assembly 15 and then the housing 20 shall vary to correspond to each application.

A hole will need to cut into the piping 10, vessel or transferring component to provide an opening for the insertion of the impeller assembly 15. A flange shall be welded to the piping 35 and a flange shall be welded to the housing 35a that will encompass the impeller assembly 15. These flanges shall bolt together and create a tight seal to prevent leakage of the fluid contained in the pipe.

The housing 20 will be made of a strong and durable material compatible with the material that the pipe, vessel or transferring component is made of. There will be a hole in each side of the housing 20 to allow the mounting shaft to pass through. The shaft will be held in place by a bearing 30 on each side of the housing.

The shaft 25 will be long enough to pass through both bearings and protrude past the housing far enough to mount a pulley 40 or type of coupling assembly. The impeller assembly 15 shall be mounted on the shaft 25 and held in place by key stock 15c and set screw 15d.

The impeller assembly 15 will capture the kinetic energy of the pressurized fluid flowing over its fins 15a. The impeller assembly 15 will then transfer the rotational energy to the shaft 25 and pulley 40 which will then transfer this energy to the device for generating electrical power 45.

The device for generating electrical power 45 then recycles the kinetic energy captured by the impeller assembly 15 to usable electrical energy. The generating device 45 will have a weatherproof cover to protect it from the weather and natural elements.

The electrical power that is created by the generator 45 then conveys the electrical power to the automatic transfer switch 55. The automatic transfer switch 55 then transfers the electrical power to each of the irrigation components dive motors for the towers 70 and the pump for the well 5. There is also the option of transferring the electrical energy back to the public power grid by the use of the automatic transfer switch 55 sending the power back to a substation.

This same process can be utilized by installing the impeller assembly 15 into the exhaust stream of air conveying systems. The kinetic energy would be captured by the impeller assembly 15 as the airflow being discharged to the atmosphere passes over it. The drive shaft 25 which is connected to the impeller assembly 15 shall convert the kinetic energy to rotational energy. This rotational energy will then drive the generator 45 producing electrical energy. This electrical energy can then be relayed by use of an automatic transfer switch 55 to a substation for public utility or more efficiently back to the industries that operated the air conveying system as a means of supplemental power.

This same process can be utilized for any man-made system that creates kinetic energy through the movement of fluid, air or combination of said energy in motion.

The said processes depicted in the figures contained in this application are not limited to the examples shown. These are merely examples to explain the process and could be subject to various ranges of size, speed, material types in reference to construction and material types in reference to material flows containing kinetic energy.

### CONCLUSION, RAMIFICATIONS, AND SCOPE OF THE INVENTION

The above process utilizes the kinetic energy that is already present in our world of manufacturing and agriculture today. The process is a means by which this kinetic energy shall be recycled into usable energy that can be reused to lessen the load on the public utility grid system. There is the benefit that exists because the energy that is creating the kinetic energy is going to be used whether the kinetic energy is recycled or not. The potential energy sources that could be utilized this process for recycling is limitless. There is the added benefit of this process is that it is as valuable in the agricultural field of business as it is in the manufacturing fields. In each of these fields of interest there is always motion of fluid and air.

This is also a process that is not limited to use in the United States of America. With the increase demand for agricultural production, there will also be additional opportunities for this process to benefit mankind. This process will also be able to be utilized in remote areas that might have limited electrical utility access.

There will also be an increase in jobs directly and indirectly related to this process. There will be the jobs related to the manufacturing of the components used in the process. There will also be jobs in the sales and installation of the equipment used for the process.

At a time when energy demands continue to increase and stress on the environment is at it's highest. This process offers a means whereby recycled usable energy to benefit all of us with no harmful impact on the environment. We have harnessed the power of nature for many years and now it is time to capture some of the man-made energy that we produce every day. Like the very essence of this process, motion is everywhere kinetic energy recycling is just collecting it to use again.

I claim:

1. A process to recycle the kinetic energy of a fluid as it is flows through a pipe, vessel or transfer component, the kinetic energy is captured by the means of a impeller assembly, water wheel or rotary device whereby kinetic energy is transferred by means of conveying rotational energy to a device for generating usable energy.

2. A process in claim 1, thereby allows the recycled hydraulic energy captured from an irrigation system, to supply a means for powering all or a portion of said irrigation system components utilizing hydraulic and/or electric energy.

3. A process in claim 1, whereby any extra recycled usable energy shall be sent back into the public power grid as electrical energy for the utility network.

4. A process in claim 1, wherein the hydraulic turbine, water wheel or rotary device is by means of cutting a hole is introduced into the fluid flow contained in a pipe, vessel or transfer component.

5. A process in claim 1, where by the use of housing shall encompass the hydraulic turbine, water wheel or rotary device and by means of a mounting device sealing the housing and pipe, vessel or transfer component thereby sealing the housing and pipe, vessel or transfer component shall prevent leakage of pressurized fluids.

6. A process to recycle the kinetic energy of air as it is flows through a pipe, vessel, chimney or transfer component. The kinetic energy is captured by the means of an impeller assembly, water wheel or rotary device. This kinetic energy is thereby transferred by means of conveying rotational energy to a device for generating usable electrical energy.

7. A process in claim 5, whereby the usable energy that was captured and recycled shall be a means for powering all or a portion of said air conveying system's components utilizing said electric energy or introducing this electric energy back into the public power grid.

8. A process in claims 1 and 6, where by kinetic energy is captured and recycled into usable energy from any form of man-made motion utilizing fluid, air or a combination of these. This new usable energy can then be reused as a supplement to the existing system or sent back to the public power utility electrical grid.
